(19) United States
(12) Patent Application Publication
(10) Pub. No.: US 2007/0107561 A1
(43) Pub. Date: May 17, 2007

(54) Wrench assembly

(76) Inventor: Robert L. Beecher, Fort Wayne, IN (US)

Correspondence Address: BARNES & THORNBURG LLP, 600 ONE SUMMIT SQUARE, FORT WAYNE, IN, 46802, US

(21) Appl. No.: 11/595,507

(22) Filed: Nov. 9, 2006

Related U.S. Application Data
(60) Provisional application No. 60/730,540, filed on Nov. 14, 2005.

(30) Foreign Application Priority Data
Nov. 14, 2005 (JP) 2005-328694

(51) Int. Cl. B25B 13/06; B25B 13/48; B25B 13/56

(52) U.S. Cl. 81/176.1; 81/121.1; 81/119

(57) ABSTRACT

A wrench assembly with increased torque capacity. The wrench assembly includes an open end wrench and a support member. The support member prevents flexing of the wrench's jaws when the wrench is under torque.

### PRIORITY CLAIM

This application claims priority to U.S. Provisional Application Ser. No. 60/730,540 filed on Nov. 14, 2005, the entire disclosure of which is hereby incorporated by reference.

### TECHNICAL FIELD

The present invention relates to wrenches and particularly to a device that prevents jaw spread of open end wrenches.

### BACKGROUND

An open end wrench is a wrench that has an open ended head used to rotate various fasteners, such as nuts and bolts. Examples of open end wrenches include but are not limited to, double open end wrenches, combination wrenches, and flare nut wrenches. An open end wrench can access fasteners under certain limited-access conditions where a closed end wrench (also known as a box wrench) cannot. For example, a closed end wrench cannot access a nut on a brake line or air conditioning line without cutting the line.

Although open end wrenches provide better access to fasteners than closed end wrenches, open end wrenches typically cannot apply as much torque to fasteners as closed end wrenches. This is due to flexing of the wrenches' jaws, also known as jaw spread, when the wrench is under torque. This weakness of open end wrenches reduces torque capacity and promotes fastener deformation and wrench wear.

There have been attempts to increase the strength and torque capacity of open end wrenches. For example, serrations have been formed on the jaws' engaging surfaces to increase grip, but this leaves bite or shred marks on the fastener. Attempts have also been made to increase torque capacity using inclined and arcuate driving surfaces.

### SUMMARY

According to one aspect, the present invention provides a wrench assembly with an open-end wrench and a support member adapted to prevent jaw spread of the wrench. In some embodiments, the wrench has an open-end head portion with spaced apart jaws. The support member is releasably coupled to the open-end head portion of the wrench and prevents relative movement of the jaws when the wrench applies torque to a fastener. In some cases, the support member includes portions adjacent exterior surfaces of the jaws. Embodiments are contemplated in which the support member extends between the jaws. Depending on the particular circumstances, the wrench's jaws may includes notches (or other openings) that receive portions of the support member. In some cases, the support member is co-planar with respect to the wrench's head portion; in other embodiments, the support member may be approximately perpendicular to the wrench. In some embodiments, the wrench's jaws are fixed with respect to each other. The support member may be configured to enclose the head portion of the wrench, in some embodiments.

According to further aspect, the present invention provides a support member for use with an open end wrench. The support member has a body adapted to be releasably coupled to the wrench. The body includes portions configured to limit flexing of the wrench's jaws. Another portion of the support member extends between the wrench's jaws. In some embodiments, the support member may be made of aluminum or steel. Embodiments are contemplated in which the support member may be a single piece unitary member.

### BRIEF DESCRIPTION OF DRAWINGS

The present disclosure will be described hereafter with reference to the attached drawings which are given as non-limiting examples only, in which:

FIG. 1 is a perspective view of a wrench assembly according to a first embodiment of the invention;

FIG. 2 is an exploded perspective view of the wrench assembly shown in FIG. 1;

FIG. 3 is a side exploded view of the wrench assembly shown in FIG. 1;

FIG. 4 is an exploded perspective view of a wrench assembly according to a second embodiment of the invention;

FIG. 5 is an exploded perspective view of a wrench assembly according to a third embodiment of the invention;

FIG. 6 is a side exploded view of a wrench assembly according to a fourth embodiment of the invention; and

FIG. 7 is a perspective view of a wrench assembly according to a fifth embodiment of the invention.

Corresponding reference characters indicate corresponding parts throughout the several views. The exemplification set out herein illustrates example embodiments of the invention, and such exemplification is not to be construed as limiting the scope of the invention in any manner.

### DETAILED DESCRIPTION OF THE DRAWINGS

It is to be understood by one of ordinary skill in the art that the present discussion is a description of exemplary embodiments only, and is not intended as limiting the broader aspects of the present invention, which broader aspects are embodied in the exemplary constructions.

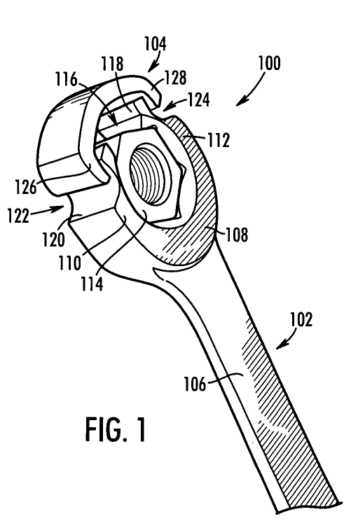

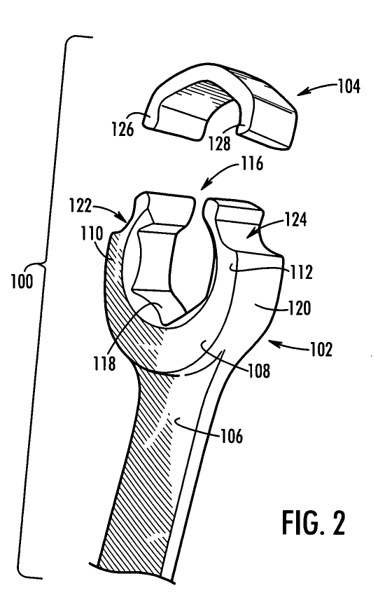

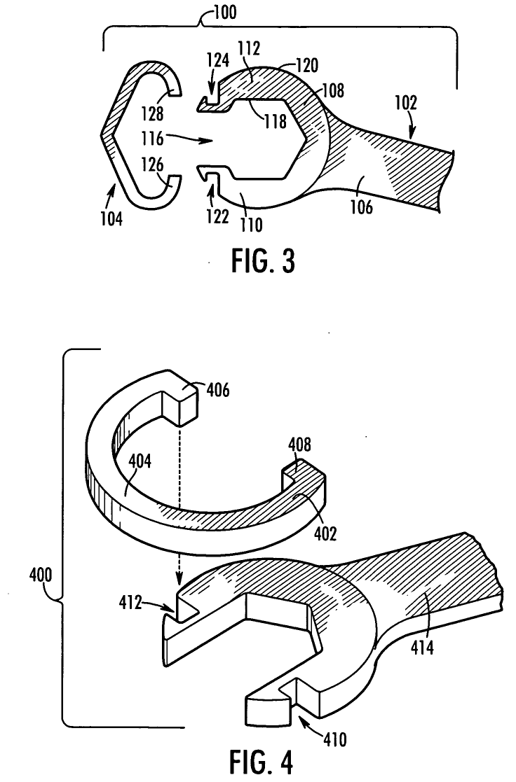

FIGS. 1-3 show a wrench assembly 100 according to an embodiment of the present invention. In the example shown, the wrench assembly 100 includes a wrench 102 and a support member 104. The support member 104 limits jaw spread when the wrench 102 is under torque.

The wrench 102 is preferably an open end wrench, such as a single open end wrench, double open end wrench, combination wrench, or flare nut wrench. As shown, the wrench 102 includes a grip portion 106, and an open end head portion 108. Although the head portion 108 is coplanar with the grip portion 106 in the example shown, embodiments are contemplated in which the head portion 108 may be angled with respect to the grip portion 106. By way of another example, the head portion 108 may be pivotally connected to the grip portion 106.

As shown, the head portion 108 includes a first jaw 110 and a second jaw 112. The jaws 110, 112 are preferably spaced apart to receive a fastener 114, such as a nut, through a receiving end 116. Although the jaws 110, 112, are fixed in the example shown, embodiments are contemplated in which the jaws 110, 112 may be adjustable to receive various sizes of fasteners. The jaws 110, 112 include an interior surface 118 configured to engage the fastener and an exterior surface 120. In the embodiment shown, the first jaw 110 includes a notch 122 and second jaw 112 includes a notch 124. Notches 122, 124 are configured to receive portions of the support member 104.

In some embodiments, the support member 104 may be releasably coupled to the wrench 102. Alternatively, a portion of the support member 104 could be permanently coupled to the wrench 104. For example, the support member 104 could be pivotally coupled to the wrench 104. The terms “couple” and “coupled” are intended broadly to encompass both direct and indirect coupling. Thus, the support member 104 and the wrench 102 are said to be coupled together when they are directly connected (e.g., by direct contact, such as an interference fit or frictional fit, of the support member 104 with the wrench 102), as well as when the support member 104 and the wrench 102 are indirectly coupled (e.g., by a hinge pivotally connecting the support member 104 to the wrench 102 or a magnetic attraction between the support member 104 and the wrench 102).

In the example shown, the support member 104 includes a first extension 126 and a second extension 128. The extensions 126, 128 are spaced apart a suitable distance to be received by the notches 122, 124. Preferably, the extensions 126, 128 frictionally engage the exterior surface 120 of the jaws 110, 112 in the notches 122, 124 in this embodiment, which reduces lateral movement. The support member 104 rigidly supports the jaws 110, 112 to prevent flexing of the jaws 110, 112 when the wrench 102 applies torque to a fastener 114. By way of example only, the support member 104 may be formed from steel or cast aluminum in some embodiments. In some cases, the support member 104 may be formed from a rigid material that is coated with plastic or rubber. Although the support member 104 is a single-piece unitary member in the example shown, embodiments are contemplated in which the support member 104 could be manufactured in multiple portions that are assembled together to form the support member 104. For example, a first portion with first extension 126 could be movable with respect to a second portion with the second extension 128 to accommodate various sizes of wrenches.

FIG. 4 shows a wrench assembly 400 according to another embodiment. In this embodiment, the wrench assembly 400 includes a support member 402 with an arcuate portion 404. A first extension 406 and a second extension 408 extend from the arcuate portion 404 to be received in notches 410, 412 of the wrench 414. In this embodiment and the embodiment shown in FIGS. 1-3, the support member 104, 402 is approximately coplanar with the head portion 108 of the wrench 102, 414.

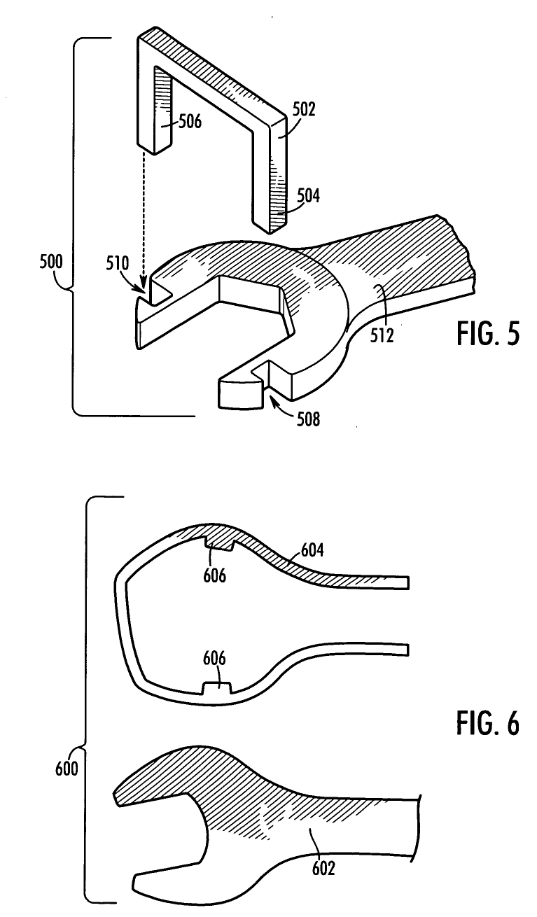

FIG. 5 shows a wrench assembly 500 according to another embodiment. In this embodiment, the wrench assembly 500 includes a support member 502 with a first extension 504 and a second extension 506 that are received in the notches 508, 510 of a wrench 512. In this embodiment, the extensions 504, 506 are approximately perpendicular to a longitudinal axis of the wrench 512.

FIG. 6 shows a wrench assembly 600 according to another embodiment. In this embodiment, the wrench 602 does not include any notches to receive the support member 604. Instead, the support member 604 is configured to tightly surround the exterior surface of the wrench 602. In some embodiments, the support member 604 may include one or more extensions 606 that prevent lateral movement of the support member 604 with respect to the wrench 602.

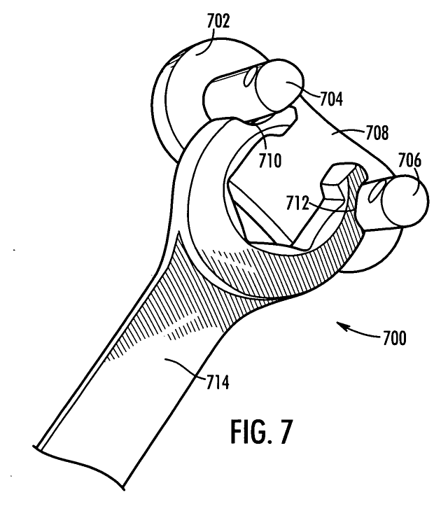

FIG. 7 shows a wrench assembly 700 according to another embodiment. In this embodiment, the support member 702 includes extensions 704, 706 that extend transversely from a base portion 708. In this example, the extensions 704, 706 are received within notches 710, 712 of a wrench 714. In some cases, the support member 702 may be a chain drive master link.

In use, a fastener 114 may be received through the receiving end 116 of the wrench 102. The support member 104 (or 402, 502, 602, or 702 in other embodiments) may then be coupled to the head portion 108 of the wrench 102. When the wrench 102 applies torque to the fastener 114, the support member 104 prevents flexing of the wrench's 102 jaws 110, 112. Accordingly, the torque capacity of the wrench 102 is increased.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

What is claimed is:

1. A wrench assembly comprising:
a wrench including an open-end head portion with a first jaw spaced apart from a second jaw; and
a support member configured to be releasably coupled to the open-end head portion, wherein the support member is configured to prevent movement of the first jaw with respect to the second jaw when the wrench applies torque to a fastener.

2. The wrench assembly of claim 1, wherein the support member includes a first portion adjacent an exterior surface of the first jaw and a second portion adjacent an exterior surface of the second jaw.

3. The wrench assembly of claim 2, wherein the first portion is configured to limit flexing of the first jaw.

4. The wrench assembly of claim 3, wherein the second portion is configured to limit flexing of the second jaw.

5. The wrench assembly of claim 4, wherein the support member extends between the first jaw and the second jaw.

6. The wrench assembly of claim 4, wherein the first portion is configured to frictionally engage at least a portion of the first jaw and the second portion is configured to frictionally engage at least a portion of the second jaw.

7. The wrench assembly of claim 4, wherein the first jaw includes at least one opening dimensioned to receive the first portion of the support member.

8. The wrench assembly of claim 7, wherein the second jaw includes at least one opening dimensioned to receive the second portion of the support member.

9. The wrench assembly of claim 4, wherein the support member defines a wrench receiving space between the first portion and the second portion, wherein at least a portion of the open end head portion is received within the wrench receiving space.

10. The wrench assembly of claim 4, wherein the support member includes an arcuate portion between the first portion and the second portion.

11. The wrench assembly of claim 1, wherein the support member includes a C-shaped portion configured to receive at least a portion of the first jaw and the second jaw.

12. The wrench assembly of claim 1, wherein the support member is approximately coplanar with respect to the open end head portion.

13. The wrench assembly of claim 1, wherein at least a portion of the support member is approximately perpendicular to a longitudinal axis of the wrench.

14. A wrench assembly comprising:
a wrench including an open-end head portion with a first jaw spaced apart from a second jaw, wherein the first jaw is fixed with respect to the second jaw;
a support member configured to be releasably coupled to the wrench, wherein the support member is configured to enclose the open end head portion of the wrench; and
wherein the support member is configured limit flexing of the first jaw and the second jaw when the wrench applies torque to a fastener.

15. The wrench assembly of claim 14, wherein an exterior surface of the first jaw includes at least one notch dimensioned to receive a first end of the support member and an exterior surface of the second jaw includes at least one notch dimensioned to receive a second end of the support member.

16. A support member for use with a wrench having an open-end head portion with a first jaw spaced apart from a second jaw, the support member comprising:
a body configured to be releasably coupled to the wrench, wherein the body comprises a first portion, a second portion extending from the first portion, and a third portion extending from the second portion;
wherein the first portion is configured to limit flexing of the first jaw;
wherein the second portion is configured to extend between the first jaw and the second jaw; and
wherein the third portion is configured to limit flexing of the second jaw.

17. The support member of claim 16, wherein the first portion is configured to be adjacent the first jaw and the third portion is configured to be adjacent to the second jaw.

18. The support member of claim 17, wherein the support member is formed from a material selected from the group consisting of aluminum and steel.

19. The support member of claim 16, wherein the support member is a single piece unitary member.

20. The support member of claim 16, wherein the first portion is configured to frictionally engage the first jaw and the third portion is configured to frictionally engage the second jaw.
